(19) United States
(12) Patent Application Publication
(10) Pub. No.: US 2004/0199313 A1
(43) Pub. Date: Oct. 7, 2004

(54) Acceleration enhancement algorithm

(75) Inventor: Darin D. Dellinger, Tipp City, OH (US)

Correspondence Address: SCOTT A. MCBAIN, DELPHI TECHNOLOGIES, INC., Legal Staff, Mail Code: 480-410-202, P.O. BOX 5052, Troy, MI, 48007, US

(73) Assignee: DELPHI TECHNOLOGIES INC.

(21) Appl. No.: 10/405,185

(22) Filed: Apr. 1, 2003

(51) Int. Cl. B60G 17/015

(52) U.S. Cl. 701/37; 280/5.5

(57) ABSTRACT

A system and method for operating a vehicle suspension system is described. A method for receiving vehicle acceleration data, determining a suspension mode based on the acceleration data, and configuring properties of the vehicle suspension system responsive to the suspension mode determination is provided. A method and system is described for a computer readable medium containing a computer program comprising computer readable code for determining a suspension mode based on received acceleration data acceleration data and, computer readable code for configuring properties of the vehicle suspension system responsive to the suspension mode determination.

### TECHNICAL FIELD OF THE INVENTION

This invention relates to vehicle suspension systems, and more particularly to provisions for operating a suspension for improved vehicle acceleration.

### BACKGROUND OF THE INVENTION

The development and application of continuously variable and magnetorheological (MR) suspension dampers allows cockpit control of certain vehicle suspension parameters. Indeed, vehicles equipped with variable suspensions are available for several markets including the so-called luxury, sport-utility and sports-car segments. Vehicles equipped with such systems usually provide driver selection among a predetermined group of suspension configurations, such as “soft ride”, “heavily loaded” and “sport,” as a few examples.

Vehicle suspension systems are generally designed for a compromise of ride comfort and road handling performance. Optimization of one suspension parameter often will result in a compromise to another. In particular, a vehicle suspension system optimized for ride comfort will be compromised for off-of-the-line acceleration performance due to chassis reaction to the torque of the driven axle. For situations such as track testing, maximum acceleration of the vehicle under test is desirable. However, even a comparatively stiff “sport” suspension configuration will not provide a maximum load transfer from the driven axle even though the suspension is tuned for performance handling at speed.

Therefore, it would be desirable to provide an improved system for operating a suspension system that overcomes these and other disadvantages.

### SUMMARY OF THE INVENTION

The present invention is directed to a system and method for operating a vehicle suspension system. The method of the invention describes receiving vehicle acceleration data, determining a suspension mode based on the acceleration data, and configuring properties of the vehicle suspension system responsive to the suspension mode determination.

In accordance with the invention, a method and system is directed to a computer readable medium containing a computer program comprising computer readable code for determining a suspension mode based on received acceleration data acceleration data and, computer readable code for configuring properties of the vehicle suspension system responsive to the suspension mode determination.

In accordance with another aspect of the invention, a vehicle including a system for operating a vehicle suspension system is provided including means for receiving vehicle acceleration data, means for determining a suspension mode based on the acceleration data, and means for configuring properties of the vehicle suspension system responsive to the suspension mode determination.

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram of a vehicle suspension system to which the method of the invention may be applied.

FIG. 2 is a block diagram in another embodiment of the system of FIG. 1 to which the method of the invention may be applied.

FIG. 3 is a block diagram of an acceleration enhancement control module in accordance with the invention.

FIG. 4 is a flow diagram of a method for operating a vehicle suspension system in accordance with the invention.

### DETAILED DESCRIPTION OF THE PRESENTLY PREFERRED EMBODIMENTS

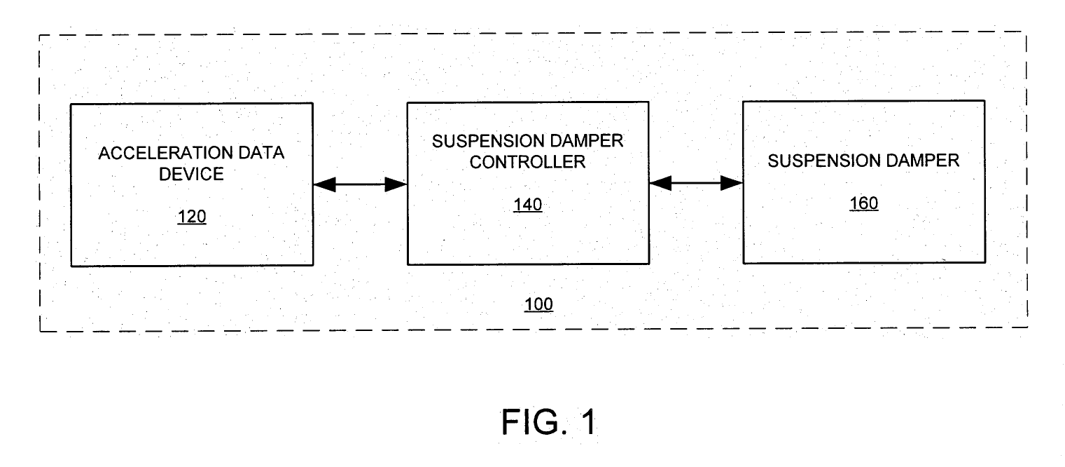

FIG. 1 is a block diagram of a vehicle suspension system to which the method of the invention may be applied. FIG. 1 shows an active vehicle suspension system 100. The active vehicle suspension system 100 (hereinafter, suspension system) is shown comprised of an acceleration data device 120, a suspension damper controller 140, and a suspension damper 160. The acceleration data device 120 is shown coupled to the suspension damper controller 140. The suspension damper controller 140 is shown coupled to the suspension damper 160.

In operation, the suspension system 100 utilizes an acceleration data device 120 (hereinafter, “data device”) to obtain acceleration data. The data device 120 is a device such as, but not limited to, an accelerometer, a positional sensor, a wheel speed sensor, a processor, and a user interface. Acceleration data is the output of an acceleration data device 120. For example, acceleration data may comprise an analog or digitally encoded signal representing a measured or estimated acceleration, a velocity, or user input representing a system parameter such as a mode-change velocity or an operating mode selection. Methods and systems for generating and interpreting acceleration data will be understood by those skilled in the art and will not be further discussed.

In operation, the suspension system 100 incorporates a suspension damper controller 140 to receive acceleration data provided by the acceleration data device 120. The suspension damper controller 140 (hereinafter, damper controller) is any device capable of providing control functions for the suspension system 100. The damper controller 140 is generally a composite device integrating one or more computer processors or microcontrollers, memory and stored computer code. The damper controller 140 is able to receive data from the data device 120 and generate a control signal based on the received data. In one embodiment, the damper controller 140 is able to query the data device for specific data. In another embodiment the damper controller 140 is able to initiate a data acquisition mode or cycle to obtain specific acceleration data. The control signal is an analog or digitally encoded signal and may represent voltages, currents, computer code instructions and the like. The damper controller 140 may be a discrete unit or integrated with other devices or systems. In one embodiment (not shown), the data device 120 and the damper controller 140 are an integrated unit. In another embodiment, the damper controller 140 and the damper 160 are integrated, although a remote primary controller unit (not shown), provides control signals to the damper controller 140. In operation, the suspension system 100 incorporates a suspension damper 160 to receive the control signal provided by the controller 140. The suspension damper 160 (hereinafter “damper”) is usually an element of an actively controlled damper assembly containing among other things, a damper such as a bi-state damper, a variable-state damper, a continuously-variable damper (CV), a magnetorheological damper (MR), and the like. The damper 160 contributes to the damping properties of a vehicle suspension. The damping and rebound properties of an active damper assembly may be changed using an appropriate control signal. The damper 160 is able to receive the control signal from the controller 140. In one embodiment, the damper 160 is able to receive and implement computer code instructions.

A suspension damper of the CV or MR variety is capable of multiple modes of controlled damping or continuously variable damping through a damping coefficient range. A control signal from the damper controller 140 is typically required to configure the damping properties of the damper 160 within a range of zero to 100 percent rebound and a range of zero to 100 percent compression. Typically, the damper controller 140 sends a control signal to the damper 160 when a suspension mode is determined. In yet another embodiment, the damper controller 140 is enabled to continuously vary the damping properties of the damper 160 responsive to signals from the damper controller 140. In one embodiment, the damper controller 140 is enabled to continuously vary the damping characteristics of the damper 160 responsive to acceleration data.

The suspension system 100 provides a vehicle with an active configurable suspension system for acceleration enhancement. The suspension system 100 typically is adjusted for ride characteristics by modulating the compression and rebound properties of the damper 160. The suspension system may have several selectable “normal” modes of operation for specific applications such as comfort mode, sport mode, or winter mode for example. For each “normal” mode selection, a predetermined variable suspension calibration is implemented at the damper 160. An acceleration enhancement mode allows the maximum force of a vehicle drive wheel to be applied to a road surface during a vehicle acceleration event.

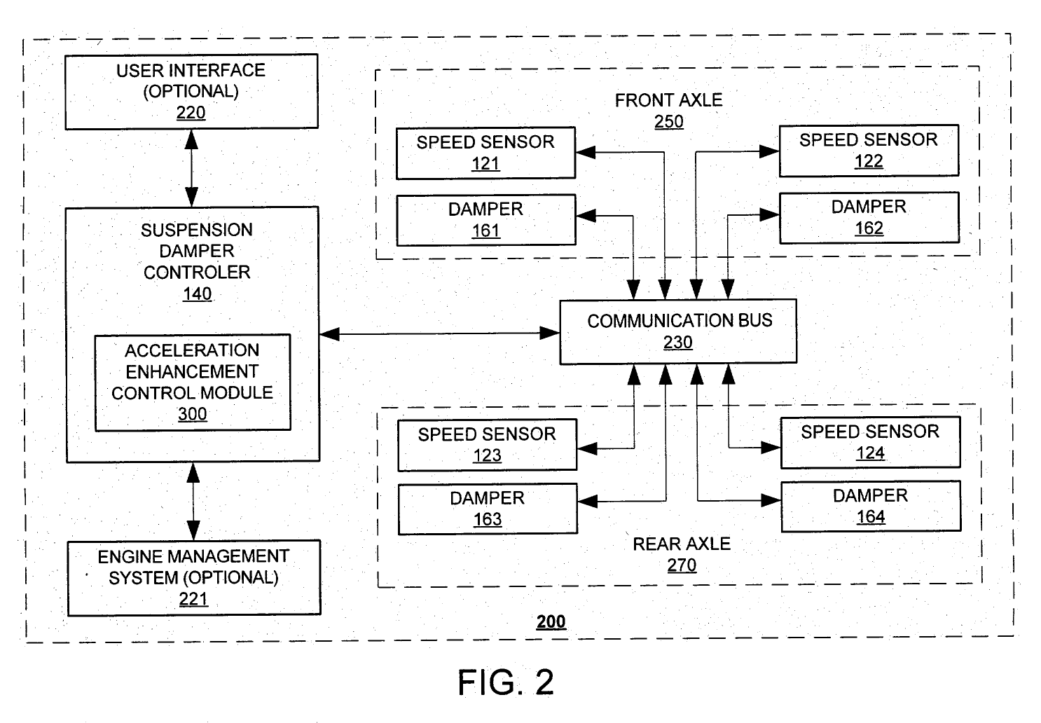

FIG. 2 is a block diagram of a second embodiment of the system of FIG. 1 to which the method of the invention may be applied. FIG. 2 shows an active vehicle suspension system 200. The active vehicle suspension system 200 comprises a suspension damper controller 140, a front axle 250, a rear axle 270, a communication bus 230, an optional user interface 220, and an optional engine management system 221. The front axle 250 comprises two wheel speed sensors 121, 122 and two suspension dampers 161, 162. The rear axle 270 comprises two wheel speed sensors 123, 124 and two suspension dampers 163, 164. The damper controller 140 comprises an acceleration enhancement control module 300. The damper controller 140 is shown coupled to the communication bus 230. The front axle 250 and the rear axle 270 are each shown coupled to the communication bus 230. The optional user interface 220 and engine management system 221 are shown coupled to the damper controller 140. In another embodiment (not shown), the optional user interface 220 and engine management system 221 may be coupled to the multiplex data bus 230. In yet another embodiment (not shown), the four suspension dampers 161, 162,163,164 may be directly connected to the suspension damper controller 140. In still another embodiment (not shown), the front axle and the rear axle have additional components at each wheel such as, for example, a wheel to body position sensor, a velocity transducer and an accelerometer.

In FIG. 2, the wheel speed sensors 121, 122, 123, 124, and the optional user interface 220 and engine management system 221 are each an acceleration a data device 120 as in FIG. 1. The dampers 161, 162, 163 and 164 are each a damper 160 as in FIG. 1. The front axle 250 and the rear axle 270 are illustrative of a vehicle having four suspension dampers 161, 162, 163 and 164 located at the four corners of the vehicle. Typically, one axle is a driven axle having engine power applied at the wheels of the axle. In one embodiment, the front axle is a driven axle. In a second embodiment, the rear axle is a driven axle. In yet another embodiment, both axles are driven, equally or proportionally.

In operation, the suspension system 200 incorporates a multiplex communication bus 230 to communicate signals between components. The multiplex communication bus is a bi-directional data bus configured to allow multiple connected devices to exchange data. Devices coupled to the multiplex communication bus 230 typically have unique addresses that allow them to be identified and accessed by other devices. Methods and systems for implementing a multiplex communication bus 230 will be known by those skilled in the art, and will not be further elaborated.

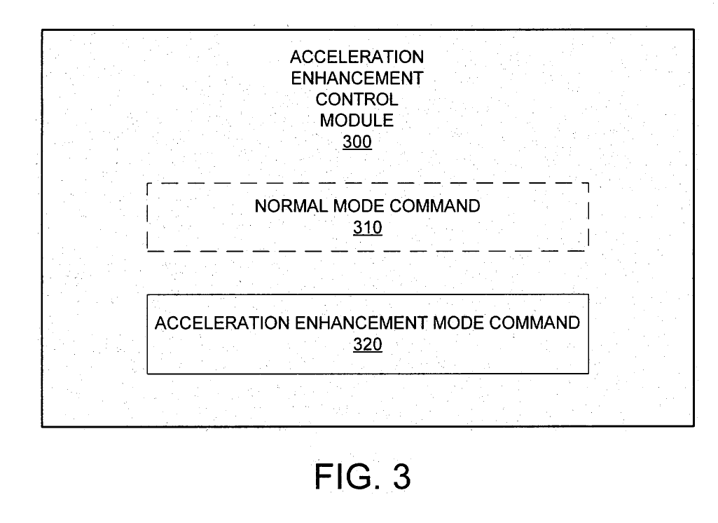

In operation, the damper controller 140 incorporates an acceleration enhancement control module 300 to provide an acceleration enhancement mode. The acceleration enhancement control module is typically a software module with specific executable routines to configure a suspension damper. A “software module” is any set of computer executable instructions, data structures and the like, or the equivalent reduced to circuits using a high-level description language, that perform a specified function when called to run as a process. Acceleration enhancement control module 300 will be discussed in detail with reference to FIG. 3.

The damper controller is generally capable of processing data from several acceleration data devices to determine, for example, a front wheel to rear wheel speed differential, vehicle velocity, average front or rear wheel speed, and a vehicle rate of change of velocity. The damper controller 140 is enabled to simultaneously compare quantities such as a determined wheel speed with a predetermined value, or the speeds of one or more different wheels. The damper controller is enabled to simultaneously configure multiple suspension dampers such as 161, 162, 163, 164, responsive to a suspension mode determination.

In operation, the optional user interface 220 may provide data received from a user to the damper controller 140. In one embodiment, a user provides data such as a suspension mode selection or a speed at which a mode change should occur, such as from an acceleration enhancement mode to a normal mode, for example. In operation, the optional engine management system 221 may provide data from an engine control system such as engine RPM, accelerator position, and the like.

FIG. 3 is a block diagram of an acceleration enhancement module in accordance with the invention. FIG. 3 shows an acceleration enhancement control module 300 comprising a normal mode command 310 and an acceleration mode command 320. The normal mode command 310 is generally a command set capable of configuring all of the suspension dampers of a vehicle for a normal operational mode. Typically, the normal mode command 310 is a default mode of the damper controller 140 or the last active mode of the damper controller prior to activation of an acceleration enhancement mode. The normal mode command 310 is not resident in the acceleration enhancement control module, but is invoked by the acceleration enhancement control module 300 to return control to the base operating mode of the damper controller 140. The normal mode command directs a signal that configures a damper 160 when directly applied to the damper 160.

The acceleration enhancement mode command 320 is generally a command set capable of configuring all of the suspension dampers of a vehicle for an acceleration enhancement operational mode. The acceleration enhancement mode command 320 is invoked by the acceleration enhancement control module 300 responsive to the damper controller 140 determining that a predetermined condition has occurred. Several conditions will invoke the acceleration enhancement control module 300. The damper controller is configured to sense an acceleration enhancement mode signal from an acceleration data device 120, such as input received to a user interface, accelerator pedal data, wheel speed sensor data and the like. In one embodiment the acceleration enhancement control module 300 is automatically invoked by the damper controlled when the predetermined conditions occur. In another embodiment, the acceleration enhancement control module 300 is only invoked based on a user input.

The acceleration enhancement control module 300 retains control of the damper configuration until an overriding condition occurs. In one embodiment, the acceleration enhancement control module 300 returns control to a base mode when a predetermined vehicle velocity is attained and a predetermined speed differential exists between front and rear wheels of the vehicle. In another embodiment, the acceleration enhancement control module 300 returns control to a base mode when a user selects a different suspension mode. In yet another embodiment, the acceleration enhancement control module 300 returns control to a base mode when a user selects a different predetermined vehicle velocity, and the determined velocity of the vehicle is less than the new predetermined value.

In one embodiment, the acceleration enhancement control module 300 comprises an algorithm represented by pseudo-code instructions such as:

Start Acceleration Enhancement Mode

Front Compression Acceleration Enhancement Damper Output—A% of full-scale damper output

Front Rebound Acceleration Enhancement Damper Output=B% of full scale damper output

Rear Compression Acceleration Enhancement Damper Output=C% of full-scale damper output

Rear Rebound Acceleration Enhancement Damper Output=D% of full scale damper output

If (vehicle road speed)>X

and

If ↑(rear wheel speed)−(front wheel speed))|<Y

then

Disable Acceleration Enhancement mode and Enable Normal mode

End if

End if.

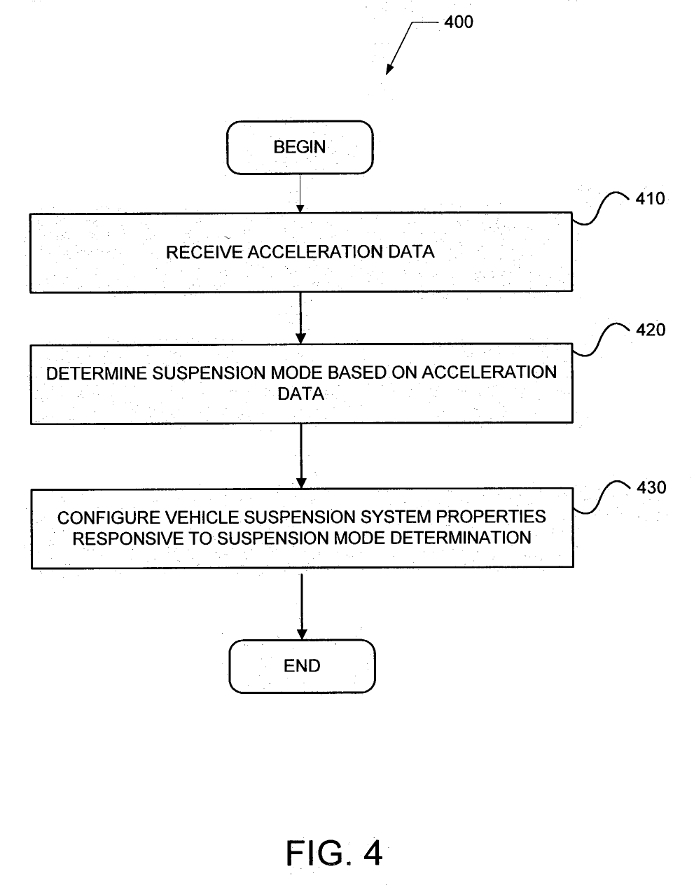

FIG. 4 is a flow diagram of a method for operating a vehicle suspension system in accordance with the invention. Process 400 begins in 410. Steps may combined, occur simultaneously or in a different order. In one embodiment, process 400 is a continuously iterative process.

In step 410, vehicle acceleration data is received from an acceleration data device. The acceleration data device is a device such as acceleration data device 120. The acceleration data may be received at any time and may be simultaneously received from multiple acceleration data devices. Generally, the acceleration data is received to a damper controller 140. The acceleration data is generally in a form that may be received by the damper controller 140.

In step 420, a suspension mode is determined based on the acceleration data. The suspension mode may be determined at any time after the acceleration data is received. Generally, the received acceleration data are processed to detect predetermined conditions and a suspension mode is selected based on the processing. Selecting a suspension mode typically comprises invoking a suspension control module, such as acceleration enhancement control module 300. In one embodiment, an acceleration enhancement mode is selected based on the detection of an acceleration enhancement mode signal. In another embodiment, an acceleration enhancement mode is selected based on a predetermined accelerator position. In yet another embodiment, an acceleration enhancement mode is selected based on a measured acceleration. In still another embodiment, a normal suspension mode is selected based on the detection of a predetermined vehicle velocity, and based on a comparison of vehicle front and rear wheel speed. A suspension mode determination may be a continuously iterative process that repeats until a condition is met, or may occur once during a process.

In step 430, properties of the vehicle suspension system are configured responsive to the suspension mode determination. The suspension system properties may be configured simultaneous with or at any time after the suspension mode is determined. Generally, the suspension properties configured include damping and rebound characteristics of a configurable damper such as suspension damper 160. Configuring the suspension system properties generally comprises generating a control signal to a damper 160 that reconfigures the damping coefficient of the damper when applied. Once the suspension system is configured process 400 is complete. In one embodiment (not shown), process 400 is continuous with step 410 following step 430.

The scope of the invention is indicated in the appended claims. We intend that all changes or modifications within the meaning and range of equivalents are embraced by the claims.

What is claimed is:

1. A method for operating a vehicle suspension system comprising:
receiving vehicle acceleration data;
determining a suspension mode based on the acceleration data; and, configuring properties of the vehicle suspension system responsive to the suspension mode determination.

2. The method of claim 1 wherein the vehicle acceleration data is the output of a device selected from the group consisting of: a longitudinal accelerometer, a positional sensor, a wheel speed sensor, a processor, and a user interface.

3. The method of claim 1 wherein determining a suspension mode comprises:
processing the vehicle acceleration data; and
selecting the suspension mode based on the processed data.

4. The method of claim 2 wherein the suspension mode is user selectable and wherein a user interface generates an acceleration enhancement mode control signal responsive to a user input.

5. The method of claim 4 wherein processing the vehicle acceleration data comprises:
sensing an acceleration enhancement mode signal.

6. The method of claim 5 wherein processing the data further comprises:
determining a vehicle front wheel speed and a vehicle rear wheel speed from the vehicle acceleration data; and
comparing the vehicle front wheel speed and rear wheel speed with predetermined criteria.

7. The method of claim 4 wherein selecting the suspension mode includes selecting a normal suspension mode wherein a difference between the vehicle front wheel speed and the vehicle rear wheel speed is less than a first predetermined value and wherein an average vehicle wheel speed is greater than a second predetermined value.

8. The method of claim 7 wherein the second predetermined value is received from a user.

9. The method of claim 4 wherein selecting the suspension mode includes selecting an acceleration enhancement suspension mode wherein a difference between the vehicle front wheel speed and the vehicle rear wheel speed is greater than a first predetermined value and wherein an average vehicle wheel speed is less than a second predetermined value.

10. The method of claim 1 wherein configuring the vehicle suspension system comprises:
configuring the suspension properties of a vehicle suspension system to provide maximum load transfer from a driven axle responsive to selecting an acceleration enhancement mode; and
configuring the suspension properties of the vehicle suspension system to provide a normal ride characteristic responsive to selecting a normal suspension mode.

11. A computer readable medium containing a computer program comprising:
computer readable code for determining a suspension mode based on received acceleration data acceleration data; and,
computer readable code for configuring properties of the vehicle suspension system responsive to the suspension mode determination.

12. The computer readable medium of claim 11 wherein computer readable code for determining a suspension mode comprises:
computer readable code for processing the vehicle acceleration data; and
computer readable code for selecting the suspension mode based on the processed data.

13. The computer readable medium of claim 12 wherein computer readable code for processing the vehicle acceleration data includes
computer readable code for sensing an acceleration enhancement control signal.

14. The computer readable medium of claim 12 wherein computer readable code for processing the data further comprises:
computer readable code for determining a vehicle front wheel speed and a vehicle rear wheel speed from the vehicle acceleration data; and
computer readable code for comparing the vehicle front wheel speed and rear wheel speed with predetermined criteria.

15. The computer readable code of claim 14 wherein selecting the suspension mode includes selecting a normal suspension mode wherein a difference between the vehicle front wheel speed and the vehicle rear wheel speed is less than a first predetermined value and wherein an average vehicle wheel speed is greater than a second predetermined value.

16. The computer readable code of claim 14 wherein selecting the suspension mode includes selecting an acceleration enhancement suspension mode wherein a difference between the vehicle front wheel speed and the vehicle rear wheel speed is greater than a first predetermined value and wherein an average vehicle wheel speed is less than a second predetermined value.

17. The computer readable medium of claim 11 wherein configuring the vehicle suspension system comprises:
configuring the suspension properties of a vehicle suspension system to provide maximum load transfer from a driven axle responsive to selecting an acceleration enhancement mode; and
configuring the suspension properties of the vehicle suspension system to provide a normal ride characteristic responsive to selecting a normal suspension mode.

18. The computer readable medium of claim 11 wherein the vehicle acceleration data is the output of a device selected from the group consisting of: an accelerometer, a positional sensor, a wheel speed sensor, a processor, and a user interface.

19. A system for operating a vehicle suspension system comprising:
means for receiving vehicle acceleration data;
means for determining a suspension mode based on the acceleration data;
means for configuring properties of the vehicle suspension system responsive to the suspension mode determination.
